(19) United States
(12) Patent Application Publication
(10) Pub. No.: US 2012/0015330 A1
(43) Pub. Date: Jan. 19, 2012

(54) METHOD OF DESIGNING A DENTAL PROSTHETIC, AND COMPUTER READABLE MEDIUM FOR PERFORMING A METHOD OF DESIGNING A DENTAL PROSTHETIC

(76) Inventor: PAUL ZHIVAGO, New York, NY (US)

(21) Appl. No.: 13/183,893

(22) Filed: Jul. 15, 2011

Related U.S. Application Data
(60) Provisional application No. 61/399,623, filed on Jul. 15, 2010.

(51) Int. Cl. A61C 5/00

(52) U.S. Cl. 433/215

(57) ABSTRACT

A method of designing a dental prosthetic is provided. The method includes converting a scanned model of at least part of a mouth of a patient into an object file adapted to be read by a three dimensional sculpting software application, and importing the object file into the three dimensional sculpting software application. The method also includes selecting a virtual target surface for the dental prosthetic in the object file, and forming a virtual negative surface from the virtual target surface. The method further includes building a dental prosthetic object file from the virtual negative surface. The dental prosthetic object file corresponds in shape to the dental prosthetic. A computer-readable medium having stored thereon computer-executable instructions is provided. The computer-executable instructions cause a processor to perform a method for creating a dental prosthetic when executed.

### CROSS-REFERENCE TO RELATED APPLICATIONS

This application claims the benefit of U.S. Provisional Application No. 61/399,623 filed Jul. 15, 2010, which is incorporated herein by reference.

### STATEMENT REGARDING FEDERALLY SPONSORED RESEARCH OR DEVELOPMENT

Not Applicable

### BACKGROUND OF THE INVENTION

1. Field of the Invention

The present invention relates to dentistry, and in particular relates to a method of designing and making dental prosthetics using a three dimensional sculpting software program.

2. Description of the Related Art

Dentistry tries to achieve an aesthetic ideal with the help of all resources available including new technologies. Modern dentistry may use visual effects to achieve better results.

Computer generated visual effects are used in the movie industry, for instance for digital effects and computer generated (for instance, animated) movies. CGI (Computer Generated Imagery) technology is used in the entertainment industry to create virtual images.

### BRIEF SUMMARY OF THE INVENTION

A method of designing a dental prosthetic is provided. The method includes converting a scanned model of at least part of a mouth of a patient into an object file adapted to be read by a three dimensional sculpting software application, and importing the object file into the three dimensional sculpting software application. The method also includes selecting a virtual target surface for the dental prosthetic in the object file, and forming a virtual negative surface from the virtual target surface. The method further includes building a dental prosthetic object file from the virtual negative surface. The dental prosthetic object file corresponds in shape to the dental prosthetic.

The method may include joining the dental prosthetic object file to the virtual target surface in the object file to form a target model object file, and displaying the target model object file to the patient.

The joining of the dental prosthetic object file to the virtual target surface to form the target model object file may include: a) aligning a first mesh of the virtual target surface with a second mesh of the virtual negative surface; b) deleting at least one unwanted virtual surface of the dental prosthetic object file; and/or c) adjusting the dental prosthetic object file using one or more brushes in a three dimensional brush palate of the three dimensional sculpting software application.

The joining of the dental prosthetic object file to the virtual target surface to form the target model object file may include fusing the first mesh of the virtual target surface with the second mesh of the virtual negative surface to form a subtool object file, and exporting the subtool object file as a .obj file. The joining may also include importing the .obj file to form a second subtool object file.

The method may include converting one of the subtool object file and the second subtool object file to a .stl file, and exporting the .stl file to one of a three dimensional printer and a multi-axis milling machine.

The converting of the scanned model into the object file may include creating a .obj file. The importing of the object file into the three dimensional sculpting software application may include importing the .obj file into the three dimensional sculpting software application.

The method may further include converting the .obj file to a further file adapted to be manipulated in the three dimensional sculpting software application.

The operation of selecting the virtual target surface in the object file may include marking the virtual target surface and creating a virtual polygon group in the further file based on the virtual target surface.

The method may include transforming the virtual polygon group into a virtual surface mask.

The building of the dental prosthetic object file may include building a virtual coping on the target surface, and building a virtual dental prosthetic surface on the virtual coping. A combination of the virtual coping and the virtual dental prosthetic surface may form the dental prosthetic object file.

The method may include digitally scanning the mouth of the patient using an intra-oral scanner to form the scanned model.

The method may include forming the dental prosthetic out of at least one of porcelain, zirconium, a composite, and a metal alloy.

The method may include bonding the dental prosthetic to an abutment tooth structure of the patient corresponding to the target surface.

The dental prosthetic may include at least one of a crown, a bridge, an onlay, an inlay, a veneer, a retainer and a dental prosthetic framework.

The method may include taking an impression of the mouth of the patient using at least one of silicon and alginate, and pouring a hardening material into the impression to form a stone model. The method may also include scanning the stone model to form the scanned model.

The method may include forming a wax model of the dental prosthetic on the stone model, and scanning the wax model using a 3D scanner.

A computer-readable medium having stored thereon computer-executable instructions is provided. The computer-executable instructions cause a processor to perform a method for creating a dental prosthetic when executed. The method includes converting a scanned model of at least part of a mouth of a patient into an object file adapted to be read by a three dimensional sculpting software application. The method also includes importing the object file into the three dimensional sculpting software application, and selecting a virtual target surface for the dental prosthetic in the object file. The method further includes forming a virtual negative surface from the virtual target surface, and building a dental prosthetic object file from the virtual negative surface. The dental prosthetic object file corresponds in shape to the dental prosthetic.

These objects and the details of the invention will be apparent from the following description and accompanying drawings.

### BRIEF DESCRIPTION OF THE DRAWINGS

FIG. 1A is a front view of a computer image of the upper dentition of a patient in accordance with an exemplary embodiment of the invention;

FIG. 1B is a perspective view of the computer image of FIG. 1A with color and texture added in accordance with an exemplary embodiment of the invention;

FIG. 1C is a perspective view of the computer image of FIG. 1B with a dental prosthetic added to the image and color changed in accordance with an exemplary embodiment of the invention;

FIG. 2A is a side perspective view of a computer image of the lower dentition of a patient in accordance with an exemplary embodiment of the invention;

FIG. 2B is a side perspective view of the computer image of FIG. 2A with a section of coping added to one of the tooth abutments in accordance with an exemplary embodiment of the invention;

FIG. 3A is a side perspective view of the computer image of FIG. 2B with a section of crown added to the section of coping in accordance with an exemplary embodiment of the invention;

FIG. 3B is a side perspective view of the computer image of FIG. 3A with a section of crown added to one tooth abutment and a crown added to another tooth abutment in accordance with an exemplary embodiment of the invention;

FIG. 4A is a side perspective view of the computer image of FIG. 3B with two crowns added to two tooth abutments and coping added to a third tooth abutment in accordance with an exemplary embodiment of the invention;

FIG. 4B is a side perspective view of the computer image of FIG. 3A with three crowns added to three tooth abutments and a three unit bridge added to other abutment teeth in accordance with an exemplary embodiment of the invention;

FIG. 5 illustrates a computer system according to an exemplary embodiment;

FIG. 6 illustrates a method according to an exemplary embodiment;

FIG. 7A is a front view of a computer image of a tooth having a coarse polygon structure in accordance with an exemplary embodiment of the invention;

FIG. 7B is a front view of a computer image of the tooth of FIG. 7A having a more refined polygon structure in accordance with an exemplary embodiment of the invention; and

FIG. 7C is a front view of a computer image of the tooth of FIG. 7A having a realistic structure and coloring in accordance with an exemplary embodiment of the invention.

### DETAILED DESCRIPTION OF THE INVENTION

Computer aided design and manufacturing (CAD/CAM) has tremendous potential to assist in the dental profession. Three dimensional (also referred to herein as 3D or 3-D) technology is also more useful in the field of dentistry.

The present invention provides an important tool in enhancing communication between patients, dentists and lab technicians, thereby improving the quality and efficiency of dental care being provided. Computer generated content can be used to illustrate the process for designing and making “a beautiful smile”, and can be used to show a patient how a proposed dental prosthetic will look on their face. Three dimensional image generating programs and content are useful to the dental profession.

Computer aided design and visualization tools can be used to design and manufacture a 3D model of provisional crowns, a bridge, an inlay, an overlay, or any other dental prosthetic, whether fixed or removable.

The following elements may be used in a method or system according to the present invention: study models of the patient, a Nextengine digital desktop scanner, Pixologic Zbrush and FaceGen software, an open source milling machine and/or an open source 3D printer which is able to read computer aided design (also referred to herein as CAD) files. The disclosed technique may use a computer running a Zbrush software application, or any other appropriate three dimensional sculpting software application. (Zbrush is referred to hereinafter interchangeably with three dimensional sculpting software application). In this manner, a better understanding and communication between the patient, dentist and the dental lab may be achieved, and a faster and more efficient manufacturing of the dental prosthetic may also be achieved.

Further alternative methods and systems may include facial generating software which can help the patient, the dental technician, and/or the dentist visualize a proposed end product. FaceGen Modeller is an example of this type of software. This program creates realistic human faces in 3D either from photos or from scratch. In this program, it is possible to edit faces with over 150 controls including age, race, gender, and also click-and-drag editing. In this manner, the practitioner can not only create and manipulate the teeth, it also possible to incorporate the teeth in a 3D version of the patient's face. Due to the fact that this program is able to modify facial features regarding age, the dentist can also predict and show the look of the face in 20 to 30 year from the present. This program works on a statistical basis and only three photos of the patient are needed to create the virtual 3D face profile.

An aging feature of FaceGen Modeller may allow jumps of 20 years and enable modification of the mandible in the aging process, as well as changes in the facial pigmentation.

Zbrush is a three dimensional sculpting application used mostly for creating detailed visual content. By using this application in a dental practice, it may be possible to get impressive aesthetic results quickly, and it may then be possible to illustrate to patients a proposed treatment plan. Zbrush has the capabilities to create simple geometric surfaces to very detailed ones. This program also gives the practitioner the capability to create surface textures. These textures may reflect light in a realistic way and can also be shaded in the manner that the practitioner desires.

Zbrush, or another three dimensional sculpting software application, may be capable of creating different surface textures. In this manner, a glossy texture and shine can be simulated. Another feature which may be useful for the practitioner is the manner in which Zbrush can simulate light sources by varying distance, intensity and color. In working with Zbrush, there may be fewer or no delays in the rendering. Modifications can be illustrated almost instantly, and it would also be a possible to do this while the patient is in the dental chair for a dental visit. The patient may be directly involved in the process, and after a consultation between the patient and the dentist, the dentist may fine tune the images and then share them further with the patient and/or the dental lab, via email or any other appropriate electronic communication mechanism. In this manner, there may be open communication between the patient and the dentist, and the patient may feel more in control of the whole process and be more actively involved. It may be important to mention to the patient that the computer generated image is only a reference point for the dentist and dental technician, and may not be an exact representation of the finished restoration.

A virtual model of an upper arch may be made out of different objects aligned in one model. The teeth, the gingiva, and every object may be created as a standing object and later combined to the full model. In this manner, the program can interchange certain objects and also modify them without having to change the whole model. The teeth can be exchanged and variations can be added. There is also a possibility to create libraries of certain types of teeth forms or shapes in order to have them ready for different facial profiles for patients and also for different age groups. Zbrush can import an object data file (also referred to herein as a .obj file) which is interchangeable in some 3D software applications, and in this manner a practitioner can import and export 3D generated meshes.

A desktop scanner, for instance a NextEngine desktop scanner, can be used to import solid dental models into Zbrush. A study model may be placed on a rotating scan platform and scanned in a 360 degree rotation in multiple layers. The amount of the layers or the resolution may be adjusted. Scanned layers are fused to create a solid virtual model. Some of the scanning results may contain surfaces which were not scanned correctly. These scanning errors can be corrected manually or with an additional scanned layer. The whole model can be made “water tight” and all holes can be closed. In this way, the model will not have holes which may be transferred and/or difficult to remove later. The water tight model may be exported in a .obj file. This type of file can be read by most kinds of 3D software programs. This file type may be exported to the Zbrush software, and may then be converted from a .obj file to .ztl file, which is the file type in which Zbrush is able to modify the object. After editing this file type in Zbrush, or another appropriate three dimensional sculpting software application, the whole 3D model, which also may include the textures created, can be exported back to a file type which is supported by a milling machine, a type of injection molding machine, and/or a 3D printer.

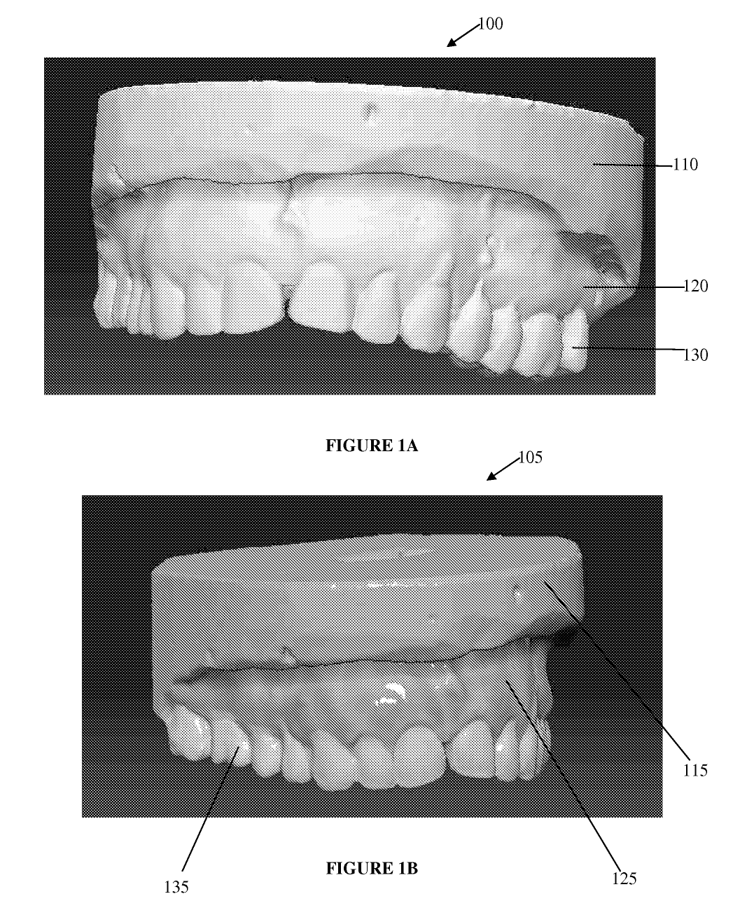

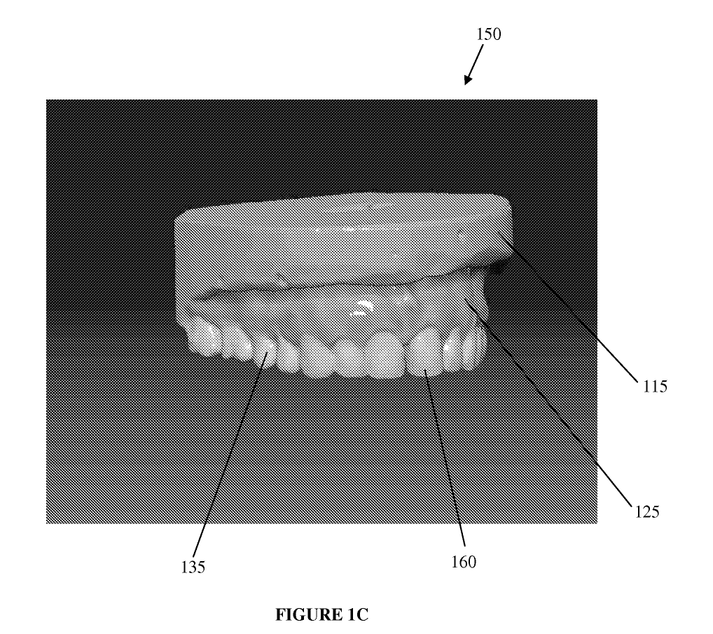

FIG. 1A is a front view of computer image 100 of the upper dentition of a patient in accordance with an exemplary embodiment of the invention. Computer image 100 includes foundation structure 110, out of which gum material 120 is structured, and out of which teeth 130 are structured. FIGS. 1A, 1B, and 1C illustrate modifying a scanned and imported model in Zbrush.

FIG. 1B is a perspective view of computer image 105, which is a refinement of the computer image of FIG. 1A, with color and texture added to foundation structure 115, gum material 125, and teeth 135 in accordance with an exemplary embodiment of the invention. The color was added to the existing model and the texture was also modified to get a glossy wet look. The patient in this case had a reversed smile line and desired a corrective prosthetic.

FIG. 1C is a perspective view of the computer image 150, which is a refinement of the computer image of FIG. 1B, with dental prosthetic 160 added to teeth 135 and the color of teeth 135 whitened (not visible in the grayscale image) in accordance with an exemplary embodiment of the invention. Foundation structure 115 and gum material 125 of FIG. 1C may be substantially the same as shown in FIG. 1B. The model was able to be modified in Zbrush to show dental prosthetic 160, and the color is able to be changed to a lighter shade to reflect possible whitening options. Computer image 150 may be presented to the patient for review for other changes, or for approval to move forward with obtaining the dental prosthetic and performing the whitening process.

This process can be done much quicker by an experienced practitioner than a conventional wax-up, pouring up the model, creating a matrix for a mock-up and placing the mock-up in a patient's mouth. This data is also transferable to the technician and the patient, and also further modifiable. The model can in this manner be exported to a program that can generate a .stl file, which can be used by a milling machine or an injection machine to produce a temporary single unit, a mock-up, a bridge or even a final restoration.

The design of a “beautiful smile” is connected to the design of an appropriate smile. An appropriate smile is determined by gender, age, and facial shape. In order to generate a natural looking smile, it is advisable to respect these variables. Providing a visual image of the corrected teeth to the patient may prevent poor treatments that fail an aesthetic standard by allowing the patient and/or dentist to avoid a result in which the appearance of the patient is “not right”.

The benefit of this technology is that there is no need to inconvenience the patient, and the practitioner can design the smile endlessly through trial and error based on the individual traits of the patient. Once the result is satisfactory to the practitioner and the patient, the image can be sent to the dental lab as a reference guide and be re-created there. In this manner, communication with the patient is improved and the patient is more active in the process, and therefore the likelihood of a satisfied patient is increased. It is imperative to ensure that the patient understands that not everything computer generated will look exactly the same in reality. However, a mock-up restoration will give the patient a better sense of the final restoration, and the computer aided design approach specified here is the next step to a more efficient and patient-oriented practice.

An exemplary method of designing and making a dental prosthetic may be as follows:

1. An impression may be taken of the current situation of a patient's mouth in the conventional manner with silicon or alginate. Alternatively, a digital impression may be taken with an intra-oral scanner (this would lead directly to step 4).

2. The model form of the impression is poured-up in stone. The stone model can now be scanned by a 3D scanner for further virtual processing (this would also lead directly to step 4).

3. A traditional wax-up can also be done on the stone model. The stone model with the wax-up can be scanned by a 3D scanner for further virtual processing.

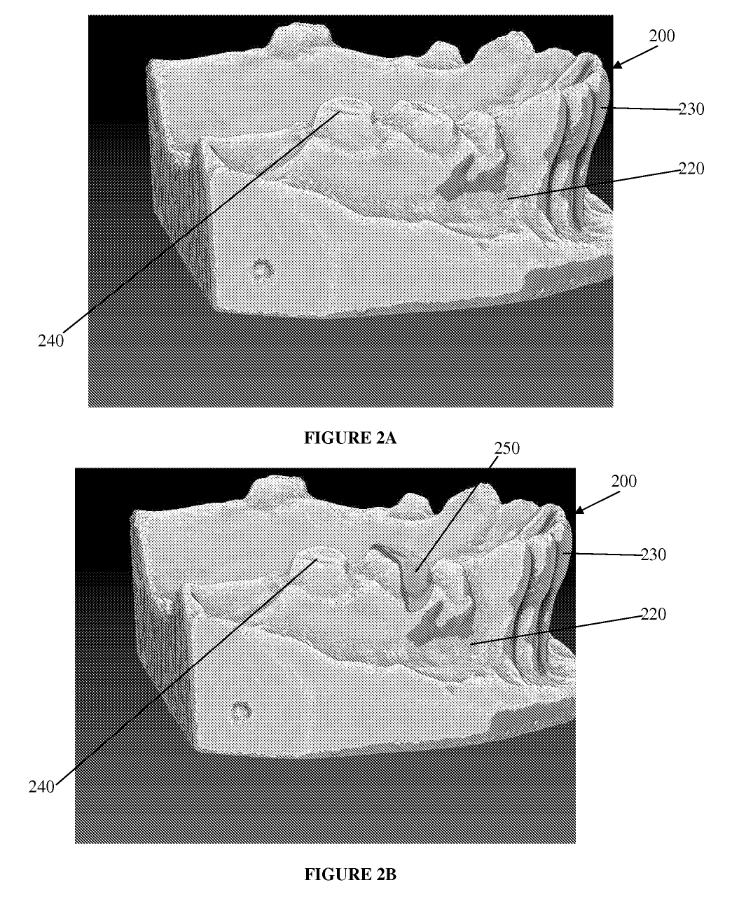

4. The scanned model, as one piece, may be converted to a .obj file which can be read by Zbrush or another three dimensional sculpting software application. This .obj file may be imported to Zbrush for further processing. FIG. 2A is a side perspective view of computer image 200 of the lower dentition of a patient in accordance with an exemplary embodiment of the invention. Computer image 200 includes an image of gum material 220 forming a foundation for teeth 230.

5. Further processing of the .obj file may be possible through converting the .obj file to a Ztool file (.ztl), which is a file that can be manipulated in Zbrush.

6. The first step to process a digital file is to mark the prepared teeth (the teeth with the deficient tooth structure), also known as abutment teeth (and illustrated in FIG. 2A as abutment teeth 240) in the case of crowns, bridges, onlay, inlays or veneers. The teeth or abutments may be marked using a key control combination, for instance “Control+Shift”, to mark the virtual model. This selection creates a different polygon group of the virtual model, and a margin of the abutment teeth or the missing tooth structure which has to be replaced. The new polygon group can also be transformed to a surface mask, which may also be a selection of a surface in a .ztl file.

A different polygon group means a marked surface on the 3D model. This different polygon group is the border and limitation for the coping. The coping is created from this different polygon group. A surface mask is also a marking on the 3D model which can be converted to a different polygon group. A surface can be masked and then converted to a different polygon group.

7. The next step may be to create the coping or the negative surface of the previous selected surface. This is needed to create a fit of the missing crown or the missing tooth structure (onlay, inlay, veneer). FIG. 2B is a side perspective view of computer image 200 of FIG. 2A with coping section 250 added to one of the tooth abutments in accordance with an exemplary embodiment of the invention. The coping of the negative surface can be produced in Zbrush with the extracting tool under the Subtool menu. Zbrush reproduces the selected or masked surface and re-creates a new mesh with a positive or negative value or thickness. This new mesh is the fit for the crown or the missing tooth structure (for example, an onlay, an inlay, or a veneer).

Typically, there is no coping when the model is scanned. The coping may be built in Zbrush in a separate operation. In the lab, the coping can be either milled separately or directly combined with the crown on top, depending on the lab technique. The coping is made in Zbrush from a different polygon group on the model. The coping is the foundation of the dental prosthetic.

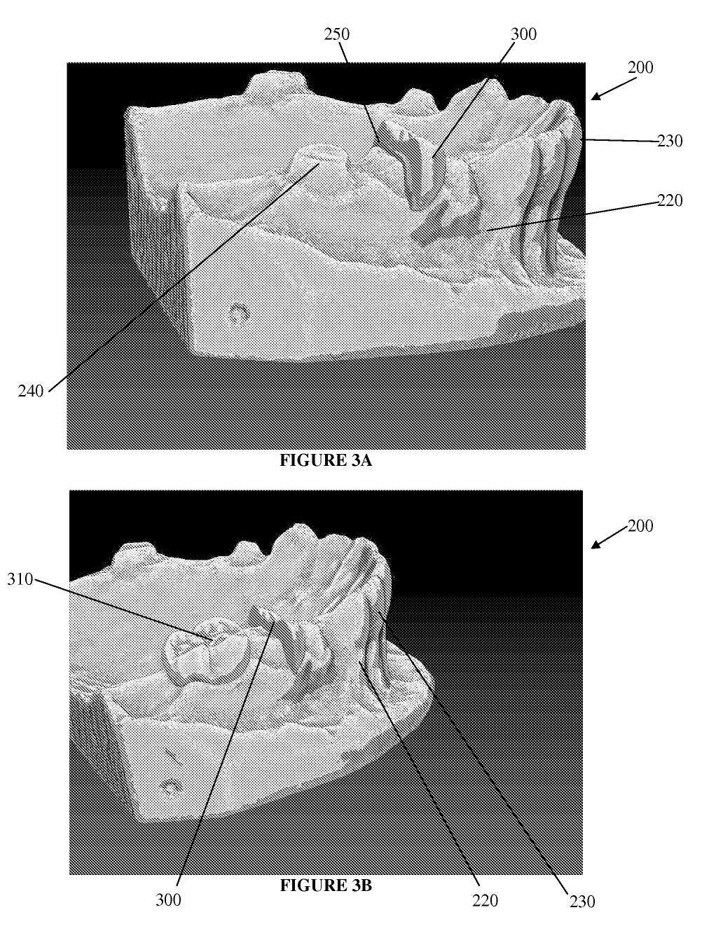

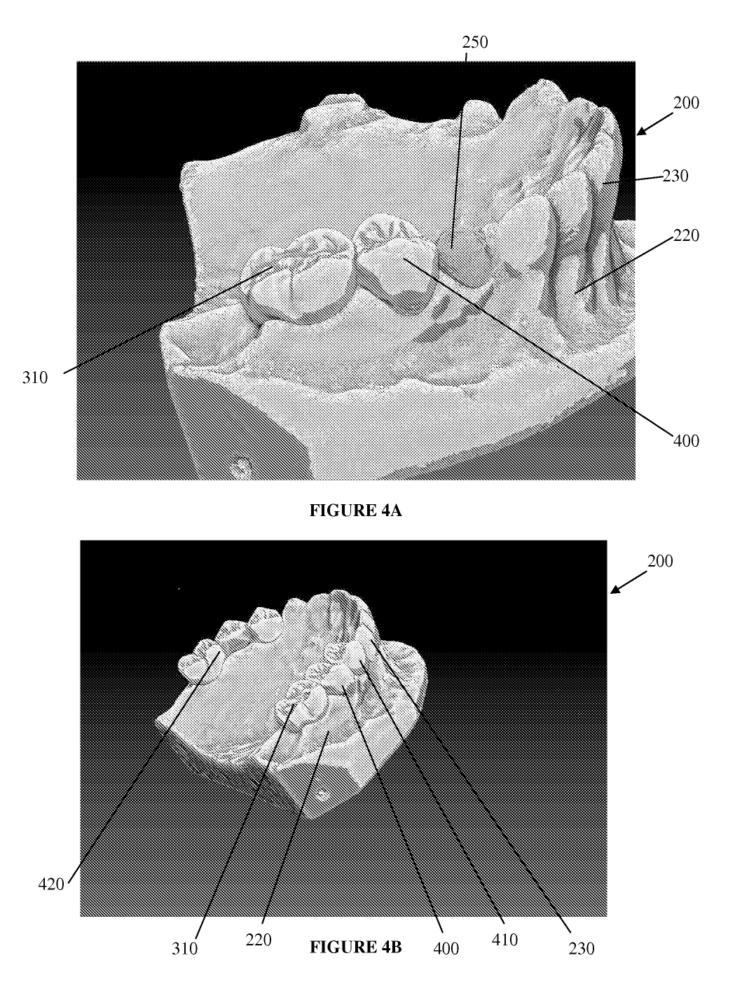

8. The next step would be to design the crown or missing part of the tooth and to shade it for presentation to the patient. This does not have to fit at this point and is only for illustration purposes for the patient and lab. The crowns or teeth can in this way be redesigned multiple times without too much effort. FIG. 3A is a side perspective view of computer image 200 of FIG. 2B with crown section 300 added to coping section 250 in accordance with an exemplary embodiment of the invention. FIG. 3B is a side perspective view of computer image 200 of FIG. 3A with a crown section 300 added to a coping section and complete crown 310 added to another tooth abutment in accordance with an exemplary embodiment of the invention. FIG. 4A is a side perspective view of computer image 200 of FIG. 3B with complete crowns 310 and 400 added to two tooth abutments and coping 250 added to a third tooth abutment in accordance with an exemplary embodiment of the invention. FIG. 4B is a side perspective view of computer image 200 of FIG. 3A with complete crowns 310, 400, and 410 added to three tooth abutments and three unit bridge 420 added to other abutment teeth, in accordance with an exemplary embodiment of the invention.

9. At this point, the dentist may present the image of the corrected teeth to the patient. The image may be presented alone or within the patient's face, and additionally, the dentist may provide an image of the altered dentition within the patient's face after a period of aging, as discussed previously using FaceGen Modeller, or a similar program. The patient may request changes that are entered by the dentist, and the dentist and patient may come to a final agreement about the proposed dental prosthetic. Once the patient accepts the design, the mesh that has been fitted to the abutment or the tooth with the missing tooth structure may be fitted to the designed crown or replacement for the missing tooth structure (onlay, inlay, veneer).

10. Next, the designed crown, bridge, onlay, inlay or veneer may be combined with the coping or negative mesh. The two meshes may need to be aligned, and overhanging meshes may be cut down and/or deleted in Zbrush by marking the unwanted surfaces and deleting them. Fine adjustments can be done with various brushes Zbrush has in the 3D brush palate. Once the fitting two meshes are aligned, the subtool master (which is a Zbrush plug-in) has the capability to fuse the two meshes into one as a subtool. Optionally at this point, the subtool may be exported as a .obj file, reimported, and converted again to another subtool. This may provide better and more predictable results in terms of the homogeneity of the mesh. The result may be a cleaner mesh having fewer distortions.

11. This mesh is now converted to a .stl file. A .stl file can be read by a 3D printer to make a temporary dental prosthetic, or by a multi-axis (for instance a five (5) axis) milling machine which can mill the desired prosthetic piece out of porcelain, zirconium, composite, metal alloy, or any other desired material for the patient's use. If the prosthetic piece is not accepted by the patient upon delivery, then steps 6-11 can be repeated.

12. The dental lab will then mill the crown, bridge, onlay, and/or inlay out of the desired material based on the exported .ztl file.

13. The patient receives the prosthetic piece. If the patient and the dentist are satisfied with the end result, the prosthetic piece can be inserted. If the patient and dentist are not satisfied, the whole process can be repeated from step 6 onward.

14. The prosthetic piece will be bonded or cemented to the abutment teeth or the missing tooth structure. The file can be kept on record in case the prosthetic piece needs replacement.

The dental prosthetic obtained from the method may be a crown, a bridge, an onlay, an inlay, a veneer, a dental prosthetic framework (either removable or permanent), a retainer, or any other appropriate dental prosthetic.

A subtool (for example a .ztl file) is the dental prosthetic file and the scanned mouth 3D object in Zbrush. Zbrush may only be able to use .ztl files. An object file (for example, a .obj file) is the dental prosthetic file for the scanner and for export to different programs. The .stl file is the dental prosthetic file for the milling machine. Different applications may use different file names, but the files may be converted between formats. The subtool is basically the object in Zbrush that is manipulated. The subtool menu provides various commands to modify the subtool. The extracting tool may be used from the subtool menu (the command menu), which enables the extraction of a new mesh from a subtool (the 3D object). An .stl file is the file that can be read by a milling machine and can be exported out of Zbrush. A .ztl file is the native file of Zbrush that enables manipulation of the 3D model in Zbrush. The .ztl file can be later converted to a .stl file for the model to be physically milled/produced.

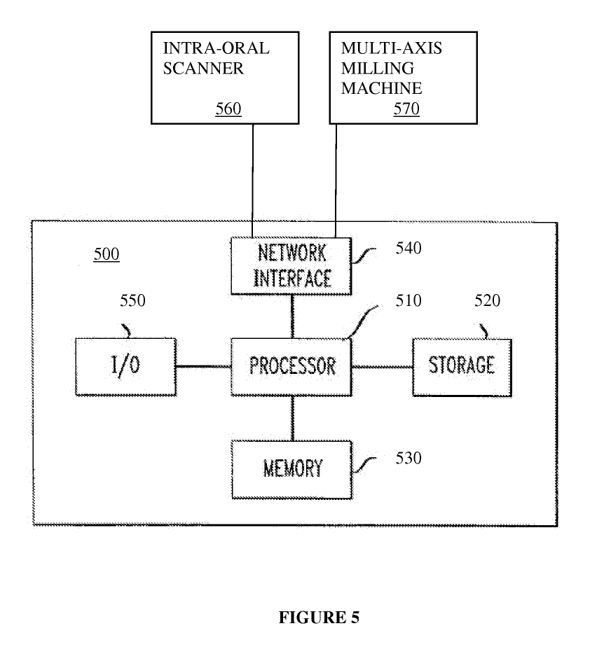

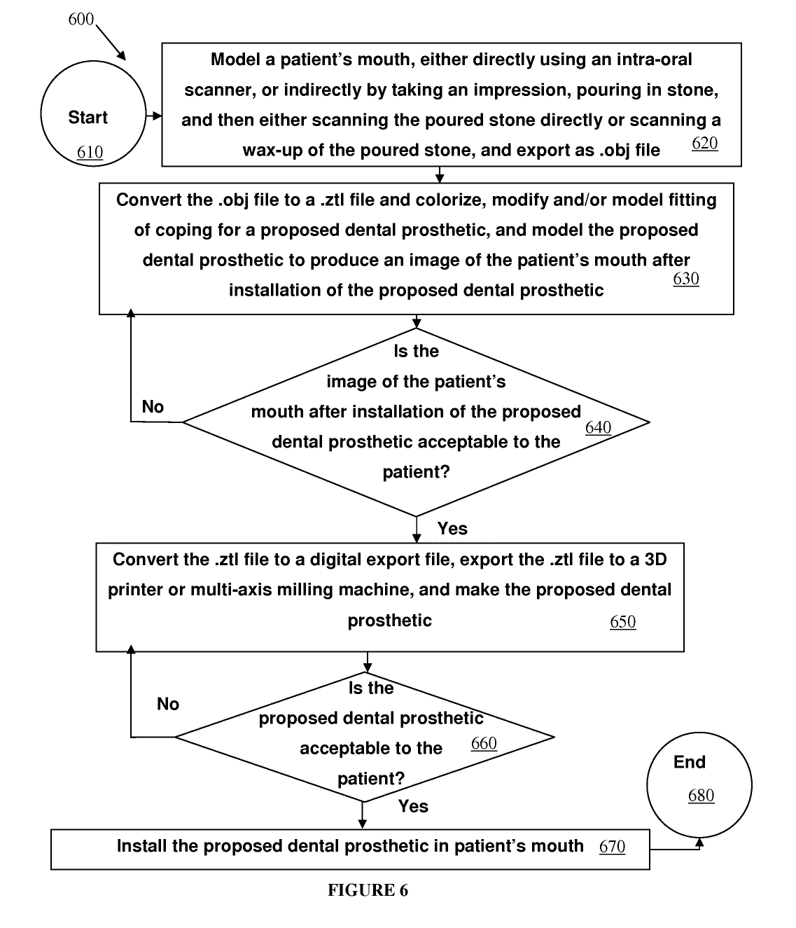

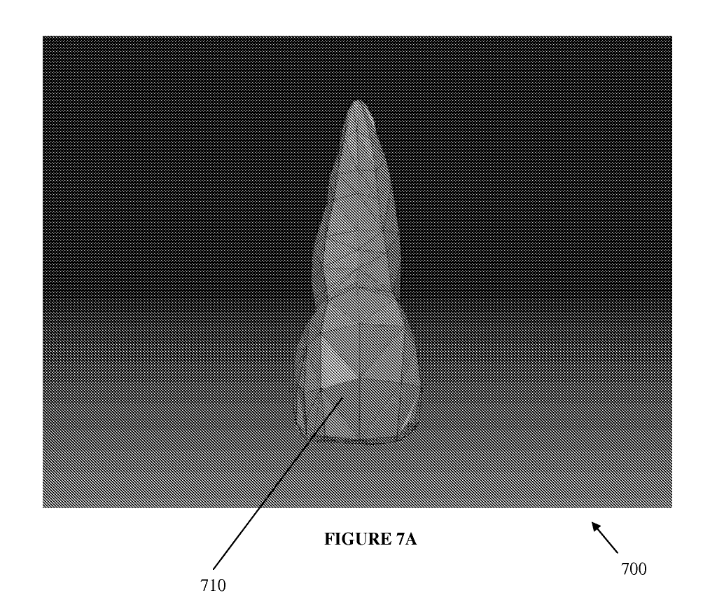

FIG. 5 illustrates a computer system according to an exemplary embodiment. Computer 500 can, for example, run a three dimensional sculpting software application, for instance Zbrush. Additionally, computer 500 can perform the steps described below (e.g., with respect to FIG. 6). Computer 500 contains processor 510 which controls the operation of computer 500 by executing computer program instructions which define such operation, and which may be stored on a computer-readable recording medium. The computer program instructions may be stored in storage 520 (e.g., a magnetic disk, a database) and loaded into memory 530 when execution of the computer program instructions is desired. Thus, the computer operation will be defined by computer program instructions stored in memory 530 and/or storage 520 and computer 500 will be controlled by processor 510 executing the computer program instructions. Computer 500 also includes one or more network interfaces 540 for communicating with other devices, for example other computers, servers, or websites. Network interface 540 may, for example, be a local network, a wireless network, an intranet, or the Internet. Computer 500 also includes input/output 550, which represents devices which allow for user interaction with the computer 500 (e.g., display, keyboard, mouse, speakers, buttons, webcams, etc.). Computer 500 may also include intra-oral scanner 560 and multi-axis milling machine 570. Alternatively, intra-oral scanner 560 may be a desktop 3D scanner used to scan a model of dentition made using conventional impression molding techniques, and multi-axis milling machine 570 may be a 3D printer or a computer controlled injection molding machine. One skilled in the art will recognize that an implementation of an actual computer will contain other components as well, and that FIG. 5 is a high level representation of some of the components of such a computer for illustrative purposes.

FIG. 6 illustrates method 600 according to an exemplary embodiment. Method 600 starts at start circle 610 and proceeds to operation 620, which indicates to model a patient's mouth, either directly using an intra-oral scanner, or indirectly by taking an impression, pouring in stone, and then either scanning the poured stone directly or scanning a wax-up of the poured stone, and export as .obj file. From operation 620, the flow proceeds to operation 630, which indicates to convert the .obj file to a .ztl file and colorize, modify and/or model fitting of coping for a proposed dental prosthetic, and model the proposed dental prosthetic to produce an image of the patient's mouth after installation of the proposed dental prosthetic. From operation 630, the flow proceeds to decision 640, which asks whether the image of the patient's mouth after installation of the proposed dental prosthetic is acceptable to the patient. If the answer to decision 640 is negative, the flow proceeds back to operation 630. If the answer to decision 640 is affirmative, the flow proceeds to operation 650, which indicates to convert the .ztl file to a digital export file, export the .ztl file to a 3D printer or multi-axis milling machine, and make the proposed dental prosthetic. From operation 650, the flow in method 600 proceeds to decision 660, which asks whether the proposed dental prosthetic is acceptable to the patient. If the answer to decision 660 is negative, the flow proceeds back to operation 650. If the answer to decision 660 is affirmative, the flow proceeds to operation 670, which indicates install the proposed dental prosthetic in patient's mouth. From operation 670, the flow in method 600 proceeds to end circle 680.

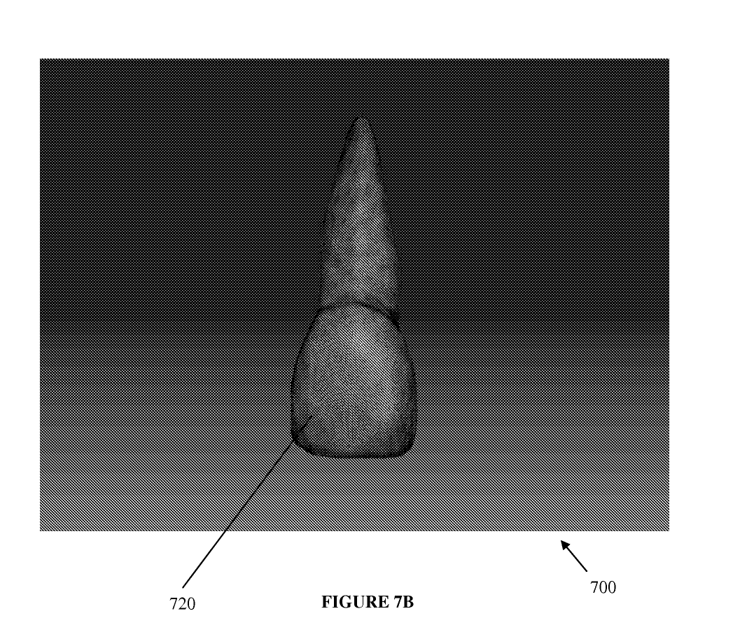

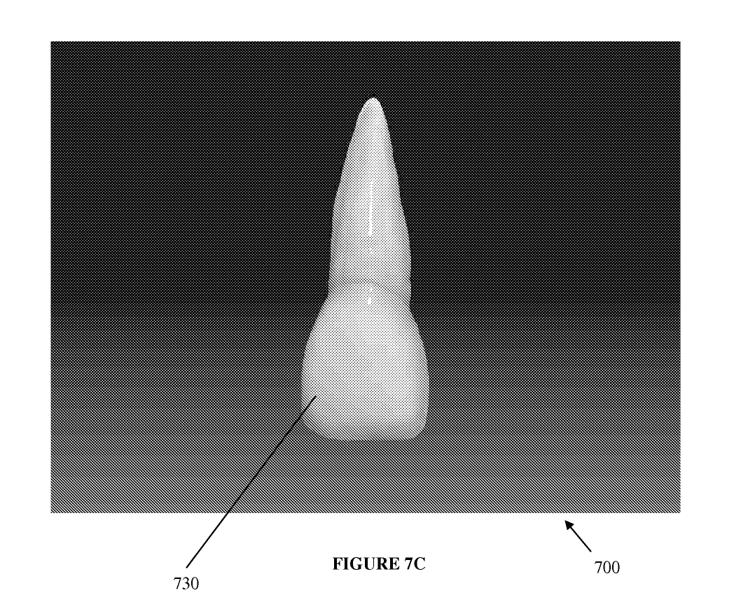

The three images of central incisor 700 shown in FIGS. 7A, 7B, and 7C show the manner in which Zbrush is able to manipulate the 3D matrix. FIG. 7A is a front view of a computer image of central incisor 700 having a coarse polygon structure in accordance with an exemplary embodiment of the invention. FIG. 7A shows a very rough form of a central molar. The whole model is composed out of very few triangles 710.

FIG. 7B is a front view of a computer image of central incisor 700 of FIG. 7A having a more refined polygon structure in accordance with an exemplary embodiment of the invention. FIG. 7B is a more detailed, higher resolution, smooth surface. Small triangles 720 that shape the surface are not clearly visible due to their increased number, and therefore small triangles 720 appear as a shadow on the surface of central incisor 700.

FIG. 7C is a front view of a computer image of central incisor 700 of FIG. 7A having a realistic structure and coloring in accordance with an exemplary embodiment of the invention. FIG. 7C illustrates central incisor 700 with smooth surface 730 having a glossy texture, which is the appropriate shading of central incisor 700. Furthermore, Zbrush, or any other appropriate three dimensional sculpting software application, is capable of creating alternative surface textures.

While only a limited number of preferred embodiments of the present invention have been disclosed for purposes of illustration, many modifications and variations could be made thereto. The present application is intended to cover all of those modifications and variations which fall within the scope of the present invention, as defined by the following claims.

I claim:

1. A method of designing a dental prosthetic, comprising:
converting a scanned model of at least part of a mouth of a patient into an object file adapted to be read by a three dimensional sculpting software application;
importing the object file into the three dimensional sculpting software application;
selecting a virtual target surface for the dental prosthetic in the object file;
forming a virtual negative surface from the virtual target surface; and
building a dental prosthetic object file from the virtual negative surface, the dental prosthetic object file corresponding in shape to the dental prosthetic.

2. The method of claim 1, further comprising:
joining the dental prosthetic object file to the virtual target surface in the object file to form a target model object file; and
displaying the target model object file to the patient.

3. The method of claim 2, wherein the joining of the dental prosthetic object file to the virtual target surface to form the target model object file comprises at least one of:
a) aligning a first mesh of the virtual target surface with a second mesh of the virtual negative surface;
b) deleting at least one unwanted virtual surface of the dental prosthetic object file; and
c) adjusting the dental prosthetic object file using one or more brushes in a three dimensional brush palate of the three dimensional sculpting software application.

4. The method of claim 3, wherein the joining of the dental prosthetic object file to the virtual target surface to form the target model object file comprises:
fusing the first mesh of the virtual target surface with the second mesh of the virtual negative surface to form a subtool object file;
exporting the subtool object file as a .obj file; and
importing the .obj file to form a second subtool object file.

5. The method of claim 4, further comprising:
converting one of the subtool object file and the second subtool object file to a .stl file; and
exporting the .stl file to one of a three dimensional printer and a multi-axis milling machine.

6. The method of claim 1, wherein:
the converting of the scanned model into the object file comprises creating a .obj file; and
the importing of the object file into the three dimensional sculpting software application comprises importing the .obj file into the three dimensional sculpting software application.

7. The method of claim 6, further comprising converting the .obj file to a further file adapted to be manipulated in the three dimensional sculpting software application.

8. The method of claim 7, wherein the operation of selecting the virtual target surface in the object file comprises marking the virtual target surface and creating a virtual polygon group in the further file based on the virtual target surface.

9. The method of claim 8, further comprising transforming the virtual polygon group into a virtual surface mask.

10. The method of claim 1, wherein the building of the dental prosthetic object file further comprises:
building a virtual coping on the target surface; and
building a virtual dental prosthetic surface on the virtual coping;
wherein a combination of the virtual coping and the virtual dental prosthetic surface forms the dental prosthetic object file.

11. The method of claim 1, further comprising digitally scanning the mouth of the patient using an intra-oral scanner to form the scanned model.

12. The method of claim 1, further comprising forming the dental prosthetic out of at least one of porcelain, zirconium, a composite, and a metal alloy.

13. The method of claim 1, further comprising bonding the dental prosthetic to an abutment tooth structure of the patient corresponding to the target surface.

14. The method of claim 1, wherein the dental prosthetic includes at least one of a crown, a bridge, an onlay, an inlay, a veneer, a retainer and a dental prosthetic framework.

15. The method of claim 1, further comprising:
taking an impression of the mouth of the patient using at least one of silicon and alginate;
pouring a hardening material into the impression to form a stone model; and
scanning the stone model to form the scanned model.

16. The method of claim 14, further comprising:
forming a wax model of the dental prosthetic on the stone model; and
scanning the wax model using a 3D scanner.

17. A computer-readable medium having stored thereon computer-executable instructions, the computer-executable instructions causing a processor to perform a method for creating a dental prosthetic when executed, the method comprising:
converting a scanned model of at least part of a mouth of a patient into an object file adapted to be read by a three dimensional sculpting software application;
importing the object file into the three dimensional sculpting software application;
selecting a virtual target surface for the dental prosthetic in the object file;
forming a virtual negative surface from the virtual target surface; and
building a dental prosthetic object file from the virtual negative surface, the dental prosthetic object file corresponding in shape to the dental prosthetic.

18. The computer-readable medium of claim 17, the method further comprising:
joining the dental prosthetic object file to the virtual target surface in the object file to form a target model object file; and
displaying the target model object file to the patient.

19. The computer-readable medium of claim 18, wherein the joining of the dental prosthetic object file to the virtual target surface to form the target model object file comprises at least one of:
a) aligning a first mesh of the virtual target surface with a second mesh of the virtual negative surface;
b) deleting at least one unwanted virtual surface of the dental prosthetic object file; and
c) adjusting the dental prosthetic object file using one or more brushes in a three dimensional brush palate of the three dimensional sculpting software application.

20. The computer-readable medium of claim 19, wherein the joining of the dental prosthetic object file to the virtual target surface to form the target model object file comprises:
fusing the first mesh of the virtual target surface with the second mesh of the virtual negative surface to form a subtool object file;
exporting the subtool object file as a .obj file; and
importing the .obj file to form a second subtool object file.
